(19) United States
(12) Patent Application Publication
(10) Pub. No.: US 2011/0133916 A1
(43) Pub. Date: Jun. 9, 2011

(54) VEHICULAR INFORMATION NOTIFICATION SYSTEM

(75) Inventors: Takeyuki Suzuki, Saitama (JP); Masayuki Sato, Saitama (JP); Yoshiyuki Matsumoto, Saitama (JP)

(73) Assignee: HONDA MOTOR CO., LTD., Tokyo (JP)

(21) Appl. No.: 13/055,548

(22) PCT Filed: Jul. 31, 2009
(86) PCT No.: PCT/JP2009/063650

§ 371 Date: Jan. 24, 2011

(30) Foreign Application Priority Data
Jul. 31, 2008 (JP) 2008-198003

(51) Int. Cl. B60Q 1/00

(52) U.S. Cl. 340/435

(57) ABSTRACT

Disclosed is a system for notifying information projected on a windshield, on the basis of a virtual image containing the information. The system controls a virtual image creation unit (23) so that the virtual image is displaced in at least one of a direction corresponding the advancing direction of a vehicle, a direction corresponding to a vertical direction with respect to the advancing direction, and a vehicle width direction. Moreover, the system controls a notification sound creation unit (24) so as to create a notification sound corresponding to the displacement of the virtual image.

### TECHNICAL FIELD

The present invention relates to a vehicular information notification system for projecting onto a windshield (windscreen) of a vehicle a virtual image that contains various information, whereby a driver is made aware of the displayed information.

### BACKGROUND ART

A variety of notification systems have been mounted in vehicles in order to make the driver aware of various information related to driving. In particular, advancements have been made in recent years in developing technology for displaying various information on the windshield, and display technology in which a virtual image is projected are well known (see, e.g., Patent Documents 1 through 4).

In the information notification systems disclosed in Patent Documents 1 through 3, a virtual image creation unit creates a virtual image, which corresponds to a forward-left edge part of the vehicle, and projects the image onto the windshield. The information notification system disclosed in Patent Document 4 relates to a projected heads-up display for aircraft, in which information concerning the heading of the aircraft and the state of equipment is projected to the operator so as to overlay the exterior field of vision.

In the information notification systems disclosed in Patent Documents 1 through 3, the focal point of the eyes of the driver is beyond the windshield when driving while viewing the distance through the windshield from within the passenger compartment. The virtual image projected on the windshield also enters the field of vision of the driver at such times. The virtual image is thus projected dimly enough to allow the area in front of the vehicle to be readily viewed through the windshield. The stimulation provided to the driver by the virtual image projected on the windshield is therefore comparatively weak. Further improvements can be made in order to use a virtual image to make the driver visually aware of information more quickly and more appropriately. These issues also apply to the information notification system disclosed in Patent Document 4.

### PRIOR ART DOCUMENTS

### Patent Document

Patent Document 1: Japanese Utility Model Application Laid-Open Publication No. 3-109925
Patent Document 2: Japanese Patent Application Laid-Open Publication No. 6-48242
Patent Document 3: Japanese Patent Application Laid-Open Publication No. 9-123797
Patent Document 4: Japanese Patent Application Laid-Open Publication No. 10-504638

### SUMMARY OF THE INVENTION

### Problems to be Solved by the Invention

It is an object of the present invention to provide a vehicular information notification system that can project an information-containing virtual image onto a windshield and make the driver aware of the information in a quick and appropriate manner.

According to one aspect of the present invention, there is provided a vehicular information notification system for displaying information on a windshield of a vehicle and making a notification corresponding to the information, which system comprises: a virtual image creation unit capable of projecting a displaceable virtual image onto the windshield; a notification sound creation unit capable of creating a notification sound, the notification sound conforming to the virtual image; and a control part for controlling the virtual image creation unit and the notification sound creation unit, wherein the control part controls the virtual image creation unit so that the virtual image is displaced on the windshield in at least one of a direction corresponding to a advancing direction of the vehicle, a direction corresponding to a vertical direction relative to the advancing direction of the vehicle, and a widthwise direction of the vehicle; and the control part controls the notification sound creation unit so that the notification sound is created to correspond to the displacement of the virtual image.

Preferably, the virtual image creation unit projects the virtual image onto the windshield at a position corresponding to a front edge of the vehicle and at a position corresponding to an edge in the widthwise direction of the vehicle.

Desirably, the vehicular information notification system further comprises an obstacle detection unit for detecting an obstacle in front of the vehicle, wherein the control part controls the virtual image creation unit so that the virtual image is projected onto the windshield, the virtual image corresponding to the obstacle detected by the obstacle detection unit.

Preferably, the notification sound creation unit creates the notification sound indicating that a lateral viewing-field line is a widthwise center of the vehicle, where the lateral viewing-field line is a straight line that passes through two points as viewed from above the vehicle, the first point being a position on a front edge of the vehicle and at a widthwise center of the vehicle, and the second point being a position corresponding to a position of the eyes of a driver driving the vehicle.

Desirably, the control part controls the notification sound creation unit so that the notification sound is created intermittently according to a relative distance between the vehicle and the obstacle.

### ADVANTAGEOUS EFFECTS OF THE INVENTION

The notification sound creation unit of the present invention creates a notification sound imparting directionality to the virtual image that is projected onto the windshield. When the virtual image projected on the windshield has been displaced, the notification sound creation unit creates the notification sound according to the displacement of the virtual image. In other words, the control unit performs a control so that the sense of directionality that the driver experiences due to the notification sound is determined so as to correspond to the displayed position of the virtual image and is linked to the virtual image. The vehicular information notification system thus produces information associating both the virtual image and the notification sound and thereby assists the driver in perceiving and evaluating the direction of the virtual image projected on the windshield and the distance in the longitudinal direction of the virtual image in relation to the windshield. In other words, the notification sound that is linked to the virtual image is used to draw the attention of the driver. The driver can be made to perceive the position of the virtual image audibly as well as visually, and can therefore be made to feel as if viewing a motion picture with sound. As a result, the driver can become aware of information more quickly and appropriately.

The virtual image creation unit projects the virtual image onto the windshield at a position corresponding to the front edge of the vehicle and at a position corresponding to the edge in the widthwise direction of the vehicle. Such a virtual image corresponds to a corner pole. The notification sound creation unit creates the notification sound imparting directionality to the virtual image corresponding to the corner post. The position of the corner post projected on the windshield can therefore be clearly ascertained. Maneuvering the vehicle to the edge of a road (aligning the vehicle with a side thereof) is therefore facilitated.

The virtual image is, e.g., displaced up or down, whereby the corner post can be made to appear to extend or retract from the viewpoint of the driver. The notification sound creation unit creates a notification sound imparting directionality to the displaced virtual image. The notification sound is heard by the driver as the sound of corner post extending and retracting. The senses of both sight and sound are used to enable the driver to perceive that the corner post is extending and retracting. As a result, the driver can more quickly and more appropriately become aware of the information contained in the virtual image that corresponds to a corner post.

The virtual image creation unit projects onto the windshield the virtual image that corresponds to an obstacle that is in front of the vehicle and was detected by the obstacle detection unit. The virtual image creation unit displaces the virtual image according to the displacement of the obstacle relative to the vehicle. The notification sound creation unit creates a notification sound imparting directionality to the displaced virtual image. The driver can therefore drive and more quickly and precisely perceive the relative direction, distance, and heading of the obstacle in relation to the vehicle.

The straight line that passes through the positions corresponding to the front-edge center position of the vehicle and the position corresponding to the vantage point of the driver when viewed from above the vehicle is the lateral viewing-field line. The seating position of the driver is offset to the left or right relative to the widthwise center of the vehicle. The lateral viewing-field line therefore often seems to be the widthwise center of the vehicle from the vantage of the seated driver.

The notification sound creation unit in the present invention therefore creates the notification sound under the assumption that the lateral viewing-field line is the widthwise center of the vehicle. In other words, displays and sounds can be used to make the driver aware of the position of the virtual image in the widthwise direction of the vehicle under the assumption that the position of the lateral viewing-field line is the widthwise center of the vehicle. The driver is therefore notified of the position of the virtual image in the form of information substantially akin to the senses of the driver.

The notification sound creation unit intermittently creates the notification sound according to the relative distance between the vehicle and the obstacle, thereby drawing the attention of the driver. The driver can therefore drive and more quickly and precisely perceive the relative distance of the obstacle in relation to the vehicle.

### BRIEF DESCRIPTION OF THE DRAWINGS

FIG. 1 is a side elevational view illustrating a vehicle employing a vehicular information notification system according to the present invention;

FIG. 2 is a view illustrating a windshield of the vehicle of FIG. 1, as seen from within a passenger compartment;

FIG. 3 is an electrical block diagram of the information notification system shown in FIG. 1;

FIG. 4 is a diagrammatical view showing a relationship between an obstacle-detection area of an obstacle detection unit, as seen from above the vehicle of FIG. 1, and left and right speakers' sound pressure;

FIG. 5 illustrates a relationship between the displacement in height of a corner-post virtual image and the frequency of the left and right speakers of the vehicular information notification system shown in FIG. 3;

FIG. 6 is a view showing a relationship between an obstacle shown in FIG. 4 and sound-pressure characteristics;

FIG. 7 is a view showing a virtual image of the obstacle is projected onto the windshield when the obstacle is detected in the vehicle of FIG. 2; and

FIG. 8 is a view showing a relationship between the displacement of the obstacle virtual image and the sound pressure of the left and right speakers of the vehicular information notification system shown in FIG. 3.

### MODE(S) FOR CARRYING OUT THE INVENTION

Certain preferred embodiments of the present invention will be described below with reference to the accompanying drawings.

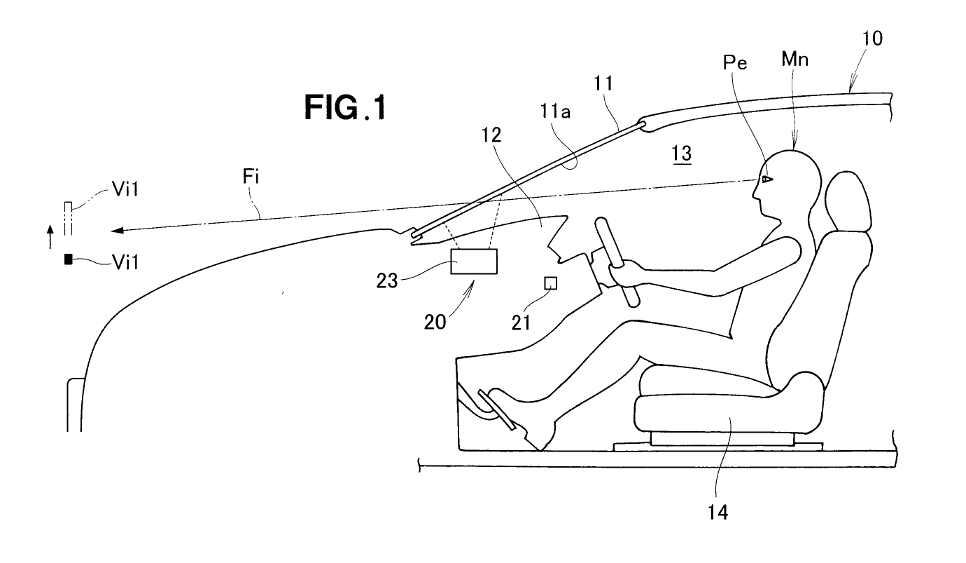

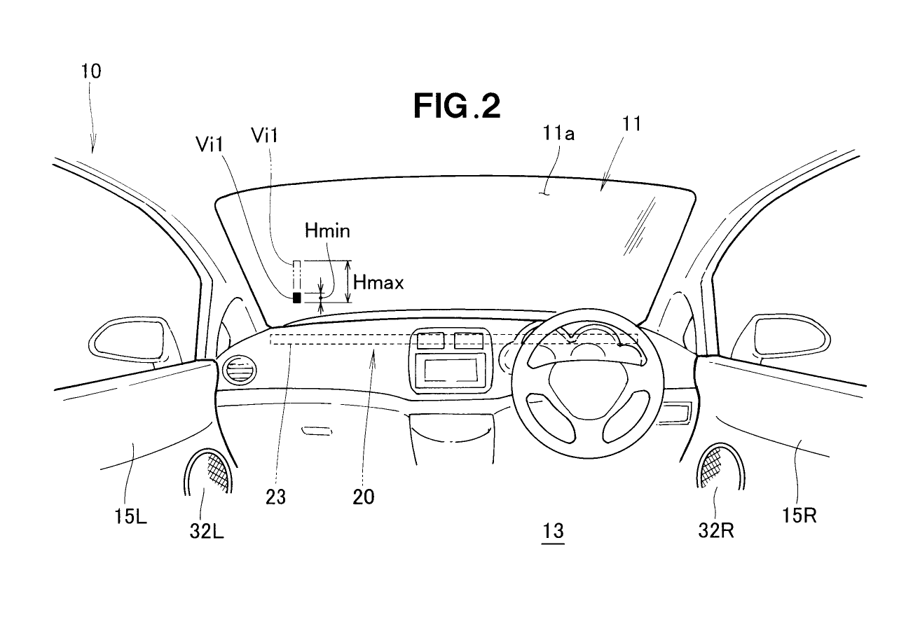

A vehicle 10 is provided with a vehicular information notification system 20, as shown in FIGS. 1 and 2. The vehicular information notification system 20 projects a virtual image Vi1, which contains various information, onto a windshield (windscreen) 11 of the vehicle 10, whereby a driver Mn is made aware of the displayed information. The vehicular information notification system also creates a notification sound, whereby the attention of the driver is drawn to the displayed information. The virtual image Vi1 is projected to correspond to, e.g., a corner post.

The corner post is a pole typically provided to a corner of the front part of the vehicle 10 and is, e.g., a marker for when the vehicle 10 moves to the edge of a road (comes into alignment with a side thereof). The corner post is eliminated in the present embodiment and is displayed by the virtual image Vi1.

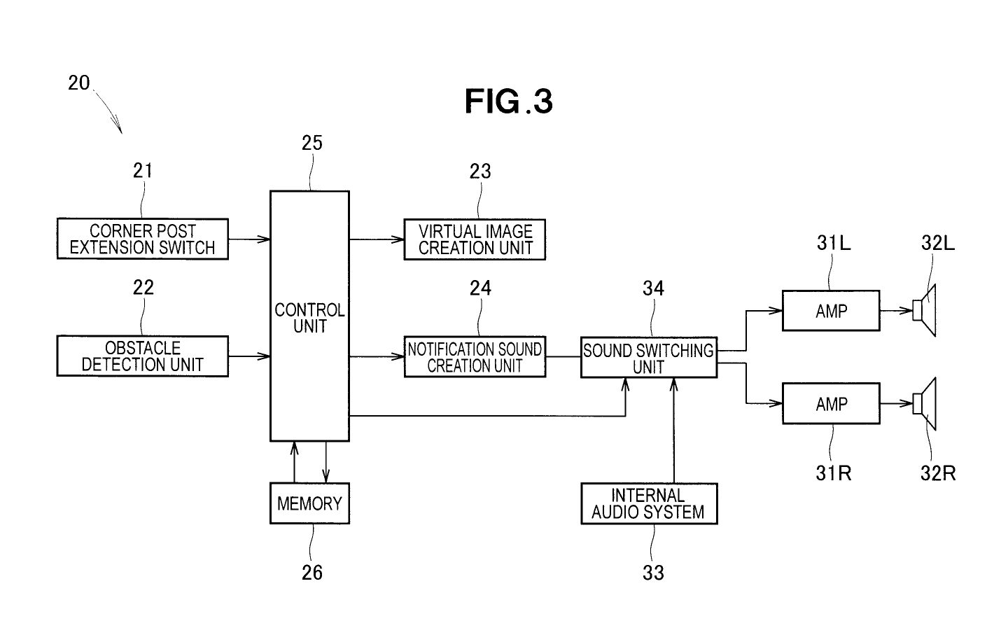

The vehicular information notification system 20 is composed of a corner post extension switch 21, an obstacle detection unit 22, a virtual image creation unit 23, a notification sound creation unit 24, and a control unit 25, as shown in FIG. 3. The vehicular information notification system 20 will be described below on the basis of FIGS. 1 through 3.

The corner post extension switch 21 is a manual switch that is operated in order to change the virtual image Vi1 corresponding to the corner post and is, e.g., attached to an installment panel 12 (FIG. 1).

The obstacle detection unit 22 detects obstacles present in front of the vehicle 10 and is positioned on the front part of the vehicle 10. More specifically, the obstacle detection unit 22 uses, e.g., radar or a camera (CCD or the like) to detect the distance and direction of obstacles relative to the vehicle 10 and calculates the relative speed of the obstacles.

The virtual image creation unit 23 is capable of projecting the virtual image Vi1 capable of being displaced by a predetermined amount onto the windshield 11 and is positioned in a location that does not interfere with the field of vision of the driver Mn; e.g., on the installment panel 12 (FIG. 1) below the windshield 11. More specifically, the virtual image creation unit 23 is composed of, e.g., a heads-up display (HUD) and projects the virtual image Vi1 onto a surface 11a (projection surface 11a) on the side of the windshield 11 facing a passenger compartment 13. The heads-up display is e.g., an assembly composed of a display device (a liquid-crystal display device or the like) that produces the display pattern of the virtual image Vi1; a light source; and a plurality of mirrors.

Illumination from the light source is directed onto the display pattern of the display device, whereby the display pattern is emitted from the display device, reflected in predetermined directions by the mirrors, and projected onto the windshield 11 as the virtual image Vi1. As a result, the single virtual image Vi1 is projected onto the windshield 11 so as to overlay the view that can be seen ahead of the windshield 11 from within the passenger compartment 13. The driver Mn sits in a driver seat 14, drives while looking forward Fr (advancing direction Fr of the vehicle 10) through the windshield 11 from within the passenger compartment 13, and can see the virtual image Vi1 projected on the windshield 11.

The notification sound creation unit 24 is capable of creating a notification sound in conformance with changes in the virtual image Vi1 and, e.g., continuously or intermittently creates sounds (notification sounds) synthesized from a variety of frequencies and sound pressures. The notification sound created by the notification sound creation unit 24 is outputted through left and right speakers 32L, 32R via amplifiers (amps) 31L, 31R. The left and right speakers 32L, 32R are respectively positioned on left and right sides in the passenger compartment 13. The phase difference and/or the sound-pressure level are adjusted in the notification sounds that are created by the notification sound creation unit 24 and outputted from the speakers 32L, 32R, thereby artificially providing a sensation of directionality.

The amplifiers 31L, 31R and the speakers 32L, 32R that are used may be, e.g., connected to a common internal audio system 33 installed in the vehicle 10. A sound switching unit 34 is used in such instances to switch between the output signal of the internal audio system 33 and the output signal of the notification sounds created by the notification sound creation unit 24. The signals are amplified by the left and right amplifiers 31L, 31R and are then outputted to the left and right speakers 32L, 32R. The speakers 32L, 32R are positioned respectively, e.g., in left and right doors 15L, 15R (FIG. 2) of the vehicle 10.

The control unit 25 receives the signals of the corner post extension switch 21 and the obstacle detection unit 22 and controls the virtual image creation unit 23, the notification sound creation unit 24, and the sound switching unit 34. The control unit is configured using, e.g., a microprocessor as the primary component and has a memory 26. The memory 26 stores in advance data for the virtual images created by the virtual image creation unit 23 and data for the notification sounds created by the notification sound creation unit 24.

The operation of the vehicular information notification system 20 having the aforedescribed configuration will be described next.

The corner post extension switch 21 will be initially considered to be in the OFF state. The control unit 25 therefore controls the virtual image creation unit 23 so that the virtual image Vi1 is created to correspond to the base part of the corner post. The virtual image Vi1 corresponding to the corner post will be referred to as the “pole virtual image Vi1” below for convenience.

The virtual image creation unit 23 projects the corner-post virtual image Vi1 onto a portion of the windshield 11 toward the front passenger seat next to the driver seat 14. When, e.g., the vehicle 10 is in a right-hand drive format, as shown in FIG. 2, the square, black corner-post virtual image Vi1 is projected onto the lower-left part of the windshield 11. The height of this corner-post virtual image Vi1 is Hmin. The notification sound creation unit 24 is in a halted state in this instance.

The position of the base part of the corner post will now be described.

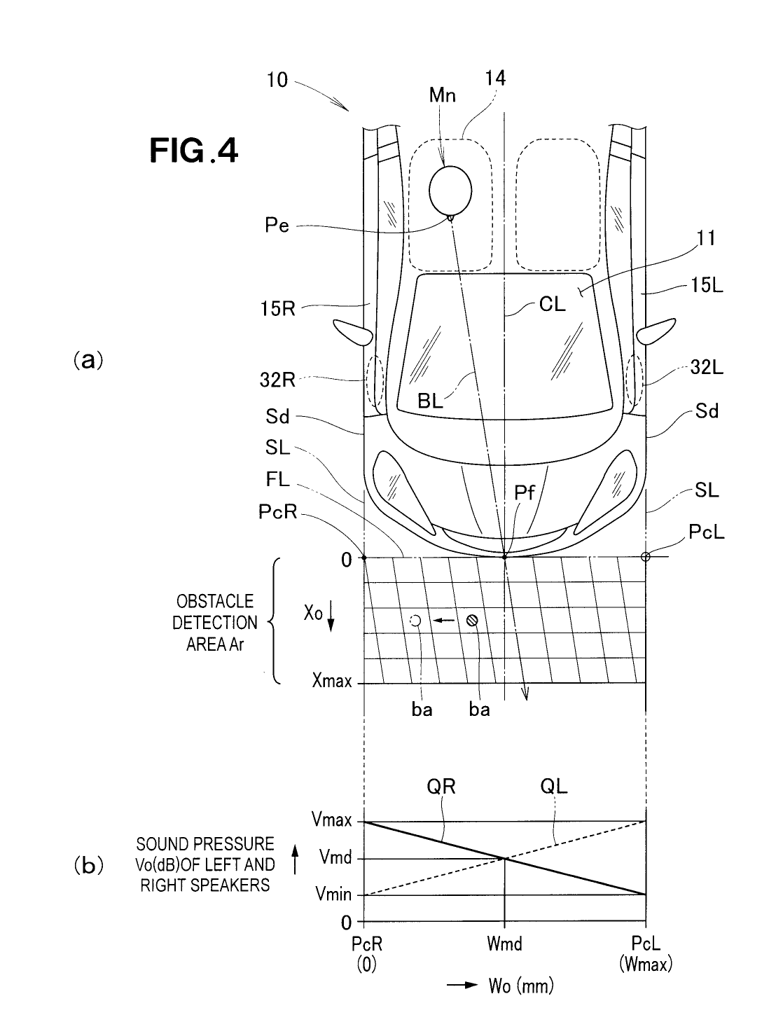

The following definitions will be used, as viewed from above the vehicle 10 as shown in FIG. 4(a). A straight line CL that extends longitudinally through the center of the vehicle 10 in the widthwise direction is the “widthwise center line CL.” A straight line FL that extends in the widthwise direction of the vehicle and contacts the front edge surface of the vehicle 10 is the “front-edge horizontal line FL.” The front-edge surface of the vehicle 10 is, e.g., the forward-most surface of the front bumper. The front-edge horizontal line FL is perpendicular to the widthwise center line CL, and a point Pf at this intersection is the “first point Pf.” In other words, the first point Pf is the position at the front end and widthwise center of the vehicle 10. A position corresponding to a position Pe of the eyes of the driver Mn that drives the vehicle 10 while seated in the driver seat 14 is the “second point Pe.” A straight line BL that passes through the two points Pf, Pe is the “lateral viewing-field line BL.”

The position corresponding to the position Pe of the eyes of the driver Mn here is set to the standard position of the driver seat 14 in the predetermined vehicle 10 and is the position corresponding to the eyes of the driver when a standard model driver is assumed to be seated in the driver seat 14.

Straight lines SL, SL that extend in the longitudinal direction in contact with left and right external lateral surfaces Sd, Sd of the vehicle 10 are “left and right external contact lines SL, SL.” Intersection points PcL, PcR between the front-edge horizontal line FL and the left and right external contact lines SL, SL are “left and right front corners PcL, PcR.” The left and right front corners PcL, PcR are positions corresponding to the FL position, which corresponds to the front edge of the vehicle 10, and positions corresponding to the edges Sd, Sd in the widthwise direction of the vehicle. The base part of the corner post is preferably positioned at the left front corner PcL when the vehicle 10 is right-hand drive.

Accordingly, the virtual image creation unit 23 in the present embodiment projects the virtual image Vi1 (shown by a black square), which corresponds to the base part of the corner post, at a position corresponding to the left front corner PcL. The corner-post virtual image Vi1 is visible to the driver Mn as shown in FIGS. 1 and 2.

The driver Mn then moves the corner post extension switch 21 shown in FIG. 3 to the ON position. The control unit 25, on receiving the ON signal, controls the virtual image creation unit 23 so as to gradually extend the length of the corner-post virtual image Vi1 upward Up. The virtual image creation unit 23 projects on the windshield 11 so that the corner-post virtual image Vi1 extends upward Up (in the direction corresponding to the vertical direction relative to the advancing direction Fr of the vehicle 10) from the base part, as shown by the imaginary lines in FIG. 2.

The control unit 25 simultaneously controls the notification sound creation unit 24 so as to create notification sounds corresponding to the change in the corner-post virtual image Vi1. The notification sound creation unit 24 creates the notification sounds according to the extending upward Up of the corner-post virtual image Vi1 from the base part. The notification sound creation unit 24 also creates notification sounds under the assumption that the lateral viewing-field line BL (FIG. 4(a)) is assumed to be at the widthwise center of the vehicle.

The control unit 25 controls the sound switching unit 34 at this time and switches the output signals. The sound switching unit 34 blocks the output signal of the internal audio system 33 and outputs the output signal of the notification sounds created by the notification sound creation unit 24 to the left and right speakers 32L, 32R via the left and right amplifiers 31L, 31R. The notification sounds that correspond to the extending upward Up of the corner-post virtual image Vi1 are therefore produced from the left and right speakers 32L, 32R.

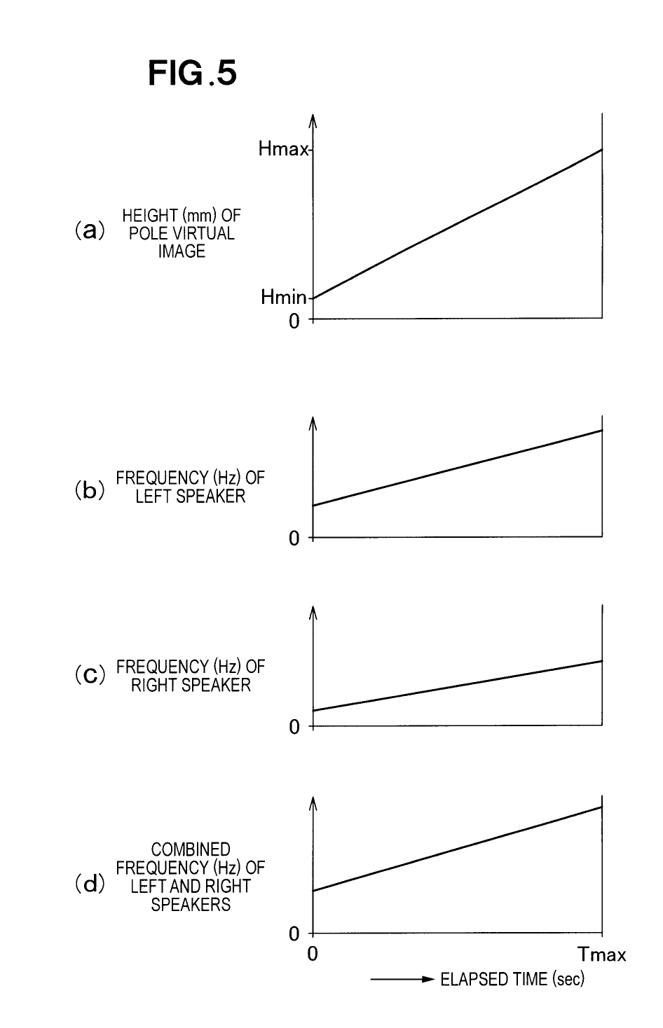

A situation in which the corner-post virtual image Vi1 extends upward Up is shown in FIG. 5. FIG. 5 shows a situation in which the corner-post virtual image Vi1 is displaced by the vehicular information notification system 20 shown in FIG. 3. The horizontal axis in FIG. 5 shows the elapsed time. FIG. 5(a) shows the change in the height of the corner-post virtual image Vi1. FIG. 5(b) shows the frequency of the notification sound that is created by the notification sound creation unit 24 and outputted by the left speaker 32L. FIG. 5(c) shows the frequency of the notification sound that is created by the notification sound creation unit 24 and outputted by the right speaker 32R. FIG. 5(d) shows the combined frequency of the notification sounds outputted by the left and right speakers 32L, 32R.

The minimum height of the corner-post virtual image Vi1 is Hmin, as shown in FIG. 5(a). The height of the pole virtual image Vi1 increases (extends) at a constant speed from the time point at which the corner post extension switch 21 is turned on (elapsed time=0) until reaching a maximum Hmax at the time point of Tmax (elapsed time=Tmax). Thereafter, when the corner post extension switch 21 is switched to the original off position, the height of the corner-post virtual image Vi1 decreases (retracts) at a constant speed from the maximum Hmax to the minimum Hmin.

The frequencies of the notification sounds outputted by the left and right speakers 32L, 32R increase as the height of the corner-post virtual image Vi1 increases and lessen as the height of the corner-post virtual image Vi1 decreases, as shown in FIGS. 5(b) through (d). In other words, the frequencies of the notification sounds are linked to the displacement of the corner-post virtual image Vi1. The notification sound creation unit 24 stops creating the notification sounds when the height of the corner-post virtual image Vi1 is in the minimum Hmin state and the maximum Hmax state.

The corner-post virtual image Vi1 is projected on the left side of the windshield 11, as shown in FIG. 2. The frequencies of the notification sounds outputted by the left and right speakers 32L, 32R are therefore set so as to correspond to the displacement of the corner-post virtual image Vi1. In other words, the frequency of the notification sound outputted by the left speaker 32L shown in FIG. 5(b) is higher than the frequency of the notification sound outputted by the right speaker 32R shown in FIG. 5(c).

Specifically, the position of the pole virtual image Vi1 projected in the windshield 11 shown in FIG. 2 corresponds to a leftward position relative to the lateral viewing-field line BL shown in FIG. 4(a). When the corner-post virtual image Vi1 is expanding or retracting, the frequency of the notification sound outputted from the left speaker 32L is therefore set so as to be higher at all time points than the frequency of the notification sound outputted by the right speaker 32R. As a result, the notification sound is more responsive with respect to the displacement of the corner-post virtual image Vi1. The driver Mn can, thereby, visually and audibly perceive the direction of the corner-post virtual image Vi1 projected on the leftward portion of the windshield 11.

The virtual image creation unit 23 thus projects the virtual image Vi1 (corner-post virtual image Vi1) onto the windshield 11 at a position corresponding to the front edge of the vehicle 10 and at a position corresponding to the edge in the widthwise direction of the vehicle. The corner-post virtual image Vi1 corresponds to a corner post. The notification sound creation unit 24 creates notification sounds in conformance with the displacement in the corner-post virtual image Vi1. The position of the corner-post virtual image Vi1 projected onto the windshield 11 (the position of the corner post) can therefore be clearly ascertained. Maneuvering the vehicle 10 to the edge of a road (aligning the vehicle with a side thereof) is therefore facilitated. If the corner-post virtual image is extended upon aligning the vehicle along the side of road, the driver can more readily see from the driver seat, and alignment is easier.

The corner-post virtual image Vi1 is, e.g., displaced up or down, whereby the corner post can be made to appear to extend or retract from the viewpoint of the driver Mn. The notification sound creation unit 24 creates notification sounds that impart directionality to the displaced corner-post virtual image Vi1. The notification sounds are heard by the driver Mn as the sounds of the corner post extending and retracting. The senses of both sight and sound are used to enable the driver Mn to perceive that the corner post is extending and retracting. As a result, the driver Mn can more quickly and more appropriately become aware of the information contained in the corner-post virtual image Vi1 that corresponds to a corner post.

The relationship between an obstacle ba detected by the obstacle detection unit 22 and notification sounds created by the notification sound creation unit 24 will be described next.

FIG. 4(a) shows an area Ar for using the obstacle detection unit 22 (see FIG. 3) to detect the obstacle ba in front of the vehicle 10, i.e., a conception of the obstacle detection area Ar, in a matrix form as viewed from above the vehicle 10. When viewed from overhead, the obstacle detection area Ar is, e.g., the range forward from the front-edge horizontal line FL of the vehicle 10 to a maximum distance Xmax, and the range from the right front corner PcR to the left front corner PcL. A detection distance Xo (forward distance Xo) in front of the vehicle 10 is zero at the position of the front-edge horizontal line FL and is Xmax at the maximum distance in the obstacle detection area Ar. A detection distance Wo (widthwise distance Wo) in the widthwise direction of the vehicle is zero at the position of the right front corner PcR and is Wmax at a maximal distance at the position of the left front corner PcL in the obstacle detection area Ar.

FIG. 4(b) shows a two-dimensional conception of sound pressure Vo of the notification sounds outputted from the left and right speakers 32L, 32R in a case in which the obstacle ba is positioned in the obstacle detection area Ar shown in FIG. 4(a). As an example, FIG. 4(b) shows a conception of sound pressure in which the obstacle ba is positioned on the front-edge horizontal line FL, where the horizontal axis is the widthwise distance Wo, and the vertical axis is the sound pressure Vo of the notification sound. The broken line in FIG. 4(b) is a left sound-pressure characteristic line QL that represents the sound-pressure characteristics of the notification sound outputted from the left speaker 32L. The solid line is a right sound-pressure characteristic line QR that represents the sound-pressure characteristics of the notification sound outputted from the right speaker 32R.

According to the left sound-pressure characteristic line QL, the sound-pressure characteristics of the notification sound outputted from the left speaker 32L are set so as to be at a minimum value Vmin when the obstacle ba is positioned at the right front corner PcR, to increase as the position of the obstacle moves left, and to be at a maximum value Vmax when the obstacle is positioned at the position of the left front corner PcL.

On the other hand, according to the right sound-pressure characteristic line QR, the sound-pressure characteristics of the notification sound outputted from the right speaker 32R are set so as to be at a minimum value Vmin when the obstacle ba is positioned at the left front corner PcL, to increase as the position of the obstacle moves right, and to be at a maximum value Vmax when the obstacle is positioned at the right front corner PcR.

The left sound-pressure characteristic line QL and the right sound-pressure characteristic line QR have characteristics such that the sound pressure decreases as the forward distance Xo shown in FIG. 4(a) increases (i.e., as the distance from the vehicle 10 to the obstacle ba increases).

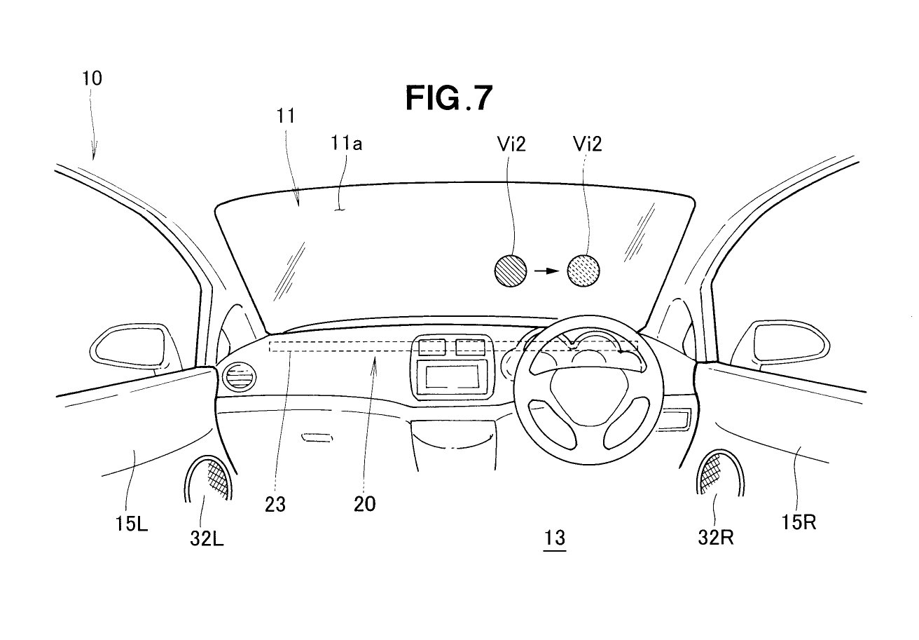

Sound-pressure characteristics are also set with reference to the lateral viewing-field line BL as viewed from above the vehicle 10 in the present embodiment. Specifically, the seating position of the driver Mn is offset to the left or right relative to the widthwise center line CL. The lateral viewing-field line BL therefore often seems to be the widthwise center of the vehicle from the vantage of the seated driver Mn. The notification sound creation unit 24 (FIG. 3) in the present embodiment therefore creates notification sounds under the assumption that the lateral viewing-field line BL is the widthwise center of the vehicle. In other words, notification sounds can be used to make the driver Mn aware of the position of a virtual image Vi2 (FIG. 7) in the widthwise direction of the vehicle under the assumption that the position of the lateral viewing-field line BL is the widthwise center of the vehicle. When the obstacle ba detected by the obstacle detection unit 22 is positioned on the lateral viewing-field line BL, the sound pressure Vo is at an intermediate value Vmd between the minimum value Vmin and the maximum value Vmax.

As described earlier, the lateral viewing-field line BL intersects the widthwise center line CL, as shown in FIG. 4(a). A position Wmd at which sound pressure is created at the intermediate value Vmd is therefore on the widthwise center line CL at the front-edge horizontal line FL (when Xo=0), as shown in FIG. 4(b).

However, the lateral viewing-field line BL veers in the widthwise direction of the vehicle with respect to widthwise center line CL as the forward distance Xo increases (i.e., as the distance from the vehicle 10 to the obstacle ba increases). The position Wmd at which sound pressure is created at the intermediate value Vmd therefore veers in the widthwise direction of the vehicle with respect to the widthwise center line CL.

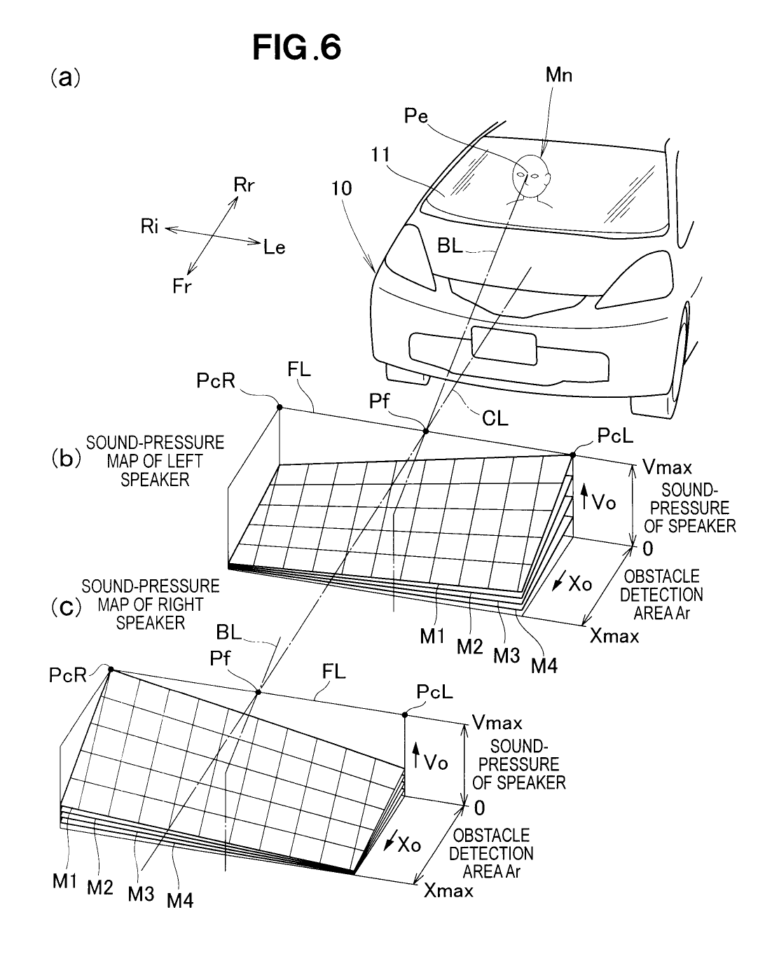

A summary of the above description of sound-pressure characteristics is given in FIG. 6. FIG. 6 shows the relationship between the obstacle ba shown in FIG. 4 and the sound-pressure characteristics, and displays the information of FIG. 4 in three dimensions. FIG. 6(b) displays a three-dimensional sound-pressure map of the notification sound outputted by the left speaker 32L on the basis of FIGS. 4(a) and (b). FIG. 6(c) displays a three-dimensional sound-pressure map of the notification sound outputted by the right speaker 32R on the basis of FIGS. 4(a) and (b).

These sound-pressure maps are stored in advance in the memory 26 shown in FIG. 3. The control unit 25 reads the sound-pressure characteristics of the sound-pressure maps from the memory 26 according to the detection signal of the obstacle detection unit 22 and outputs these maps as a control signal to the notification sound creation unit 24. The notification sound creation unit 24 creates notification sounds having the characteristics of the sound-pressure maps according to the control signal and causes these sounds to be outputted from the left and right speakers 32L, 32R.

As shown in FIGS. 6(a), (b), the sound-pressure characteristics of the notification sounds outputted from the left and right speakers 32L, 32R (FIG. 4) are set so as to change according to the relative speed between the obstacle ba (FIG. 4), which is detected by the obstacle detection unit 22, and the vehicle 10. In other words, the sound pressure increases as the relative speed increases. The maps in FIG. 6(b) are, e.g., employed from top to bottom in stages as the relative speed decreases in relation to a plurality of threshold values that are set in advance.

More specifically, the control unit 25 selects and employs the plurality of maps as follows. When the relative speed is equal to or greater than the highest first threshold value, a first map M1 at the highest level is employed. When the relative speed is less than the first threshold value and greater than or equal to the next lower second threshold value, a second map M2 below the first map is employed. When the relative speed is less than the second threshold value and greater than or equal to the next lower third threshold value, a third map M3 is employed. When the relative speed is less than the third threshold value and greater than or equal to the next lower fourth threshold value, a fourth map M4 is employed.

FIG. 7 shows the vehicle shown in FIG. 2 in a state in which an obstacle has been detected. When the obstacle detection unit 22 shown in FIG. 3 has detected the obstacle ba (FIG. 4(a)) in front of the vehicle 10, the control unit 25 controls the virtual image creation unit 23 according to the detection signal so that the virtual image Vi2 (referred to as the obstacle virtual image Vi2 below) is created to correspond to the obstacle ba. The obstacle virtual image Vi2 may be a symbolic shape for showing the location of the obstacle ba and is, e.g., a marker for indicating the type of the obstacle ba or an outline corresponding to the external appearance of the obstacle ba. The virtual image creation unit 23 projects the obstacle virtual image Vi2 onto the windshield 11. The obstacle virtual image is shown by solid lines in FIG. 7. When the detected obstacle ba is, e.g., positioned to the right of the widthwise center of the vehicle, the obstacle virtual image Vi2 is also positioned to the right of the widthwise center of the vehicle.

The control unit 25 simultaneously controls the notification sound creation unit 24 so as to create notification sounds imparting directionality to the obstacle virtual image Vi2 in association with the position of the obstacle virtual image Vi2. The notification sound creation unit 24 creates the notification sounds according to the position of the obstacle virtual image Vi2. The control unit 25 controls the sound switching unit 34 at this time and switches the output signals. The sound switching unit 34 blocks the output signal of the internal audio system 33 and outputs the output signal of the notification sounds created by the notification sound creation unit 24 to the left and right speakers 32L, 32R via the left and right amplifiers 31L, 31R. The notification sounds that correspond to the position of the obstacle virtual image Vi2 are therefore produced from the left and right speakers 32L, 32R. The notification sound creation unit 24 creates intermittent notification sounds at a constant pitch when the obstacle virtual image Vi2 is projected onto the windshield 11.

Thereafter, when the obstacle detection unit 22 detects the obstacle ba moving to the right relative to the vehicle 10, the control unit 25 controls the virtual image creation unit 23 according to the detection signal so that the obstacle virtual image Vi2 is made to move to the right to correspond to the obstacle ba. The virtual image creation unit 23 causes the obstacle virtual image Vi2 projected onto the windshield 11 to move to the position shown by the imaginary lines.

The control unit 25 simultaneously controls the notification sound creation unit 24 so as to create notification sounds imparting directionality to the obstacle virtual image Vi2 in association with the position of the obstacle virtual image Vi2. The notification sounds are created according to the displacement of the obstacle virtual image Vi2.

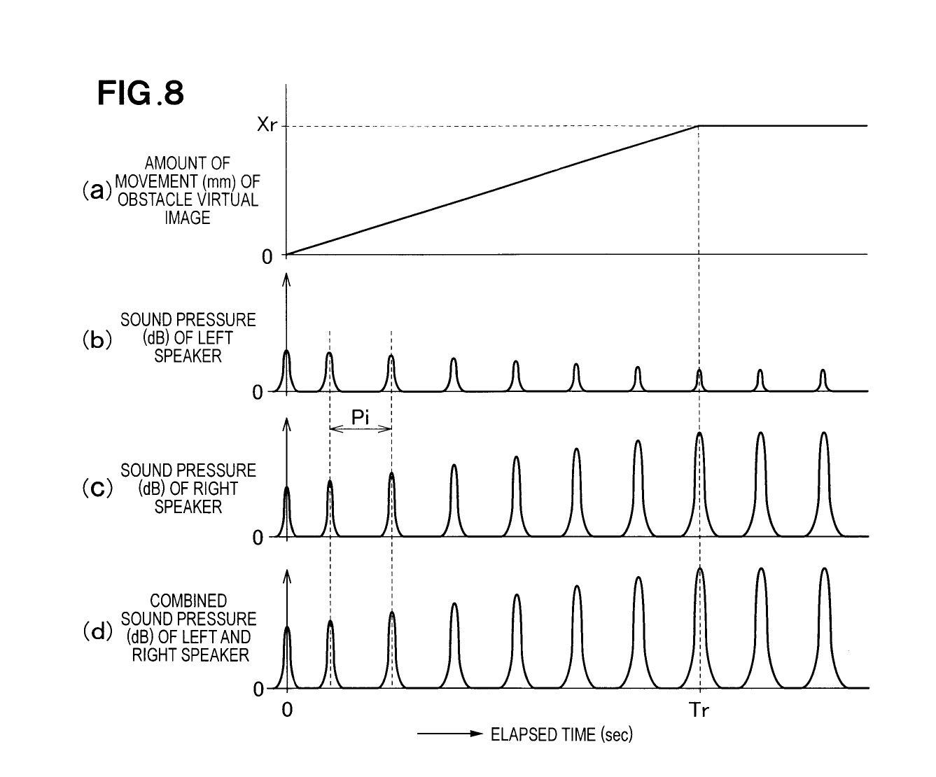

A situation in which the obstacle virtual image Vi2 moves further right from a position to the right of the widthwise center of the vehicle is shown in FIG. 8. FIG. 8 is a graph that shows the displacement of the obstacle virtual image Vi2 due to the vehicular information notification system 20 shown in FIG. 3. The horizontal axis in FIG. 8 represents elapsed time. FIG. 8(a) shows the change in the amount of movement when the obstacle virtual image Vi2 moves to the right relative to the vehicle 10. FIG. 8(b) shows the sound pressure of the notification sound outputted by the left speaker 32L. FIG. 8(c) shows the sound pressure of the notification sound outputted by the right speaker 32R. FIG. 8(d) shows the combined sound pressure of the notification sounds outputted from the left and right speakers 32L, 32R.

The obstacle virtual image Vi2 is presumed to be in a position to the right of the widthwise center of the vehicle in FIG. 8(a) (see FIG. 7). In other words, the amount of movement is zero when the elapsed time is zero. Because the obstacle virtual image Vi2 is at a position to the right of the widthwise center of the vehicle, the sound pressure of the notification sound outputted by the left speaker 32L shown in FIG. 8(b) is smaller than the sound pressure of the notification sound outputted by the right speaker 32R shown in FIG. 8(c). The combined sound pressure of the notification sounds outputted by the left and right speakers 32L, 32R in this case is as shown in FIG. 8(d).

Thereafter, the obstacle virtual image Vi2 moves further to the right relative to the vehicle 10, and, after moving by an amount Xr after an elapsed time Tr has passed, stops at that position. During the passage of the elapsed time Tr, the obstacle virtual image Vi2 moves further to the right from the widthwise center of the vehicle, and therefore the sound pressure of the notification sound outputted by the left speaker 32L shown in FIG. 8(b) gradually decreases and is maintained at the decreased sound pressure after reaching the time point at which the elapsed time Tr has passed. In contrast, the sound pressure of the notification sound outputted by the right speaker 32R shown in FIG. 8(c) gradually increases and is maintained at the increased sound pressure after reaching the time point at which the elapsed time Tr has passed. The combined sound pressure of the notification sounds outputted by the left and right speakers 32L, 32R in this case is as shown in FIG. 8(d).

The virtual image creation unit 23 thus displaces the obstacle virtual image Vi2 according to the displacement of the obstacle ba relative to the vehicle 10. The notification sound creation unit 24 creates notification sounds to impart directionality to the displaced obstacle virtual image Vi2. The driver Mn can therefore drive and more quickly and precisely perceive the relative direction, distance, and heading of the obstacle ba in relation to the vehicle 10.

When the obstacle detection unit 22 has detected the obstacle ba, the notification sound creation unit 24 creates intermittent notification sounds at a constant pitch Pi that is set in advance, as shown in FIG. 8. In other words, the notification sound creation unit 24 intermittently creates the notification sounds according to the relative distance between the vehicle 10 and the obstacle ba, thereby drawing the attention of the driver Mn. The driver Mn can therefore drive and more quickly and precisely perceive the relative distance of the obstacle ba in relation to the vehicle 10.

The virtual image creation unit 23 thus projects onto the windshield 11 the virtual image Vi2 (obstacle virtual image Vi2) that corresponds to the obstacle ba that is in front of the vehicle 10 and was detected by the obstacle detection unit 22. The virtual image creation unit 23 displaces the obstacle virtual image Vi2 according to the relative displacement of the obstacle ba in relation to the vehicle 10. The notification sound creation unit 24 creates notification sounds corresponding to the displaced obstacle virtual image Vi2. The driver Mn can therefore drive and more quickly and precisely perceive the relative direction, distance, and heading of the obstacle ba in relation to the vehicle 10.

The straight line that passes through the positions corresponding to the front-edge center position Pf of the vehicle 10 and vantage point Pe of the driver Mn when viewed from above the vehicle 10 is the lateral viewing-field line BL. The seating position of the driver Mn is offset to the left or right relative to the widthwise center line CL in the vehicle 10. The lateral viewing-field line BL therefore often seems to be the widthwise center of the vehicle from the vantage of the seated driver Mn. The notification sound creation unit 24 accordingly creates notification sounds under the assumption that the lateral viewing-field line BL is the widthwise center of the vehicle. In other words, displays and sounds can be used to make the driver Mn aware of the position of a virtual image Vi2 in the widthwise direction of the vehicle under the assumption that the position of the lateral viewing-field line BL is the widthwise center of the vehicle. The driver Mn is therefore notified of the position of the obstacle virtual image Vi2 in the form information substantially akin to the senses of the driver.

A summary of the vehicular information notification system 20 described above is as follows.

The notification sound creation unit 24 creates notification sounds to impart directionality to the virtual images Vi1, Vi2 that are projected onto the windshield 11. When the virtual images Vi1, Vi2 projected on the windshield 11 have been displaced, the notification sound creation unit 24 creates notification sounds to impart directionality to the displaced virtual images Vi1, Vi2. In other words, the control unit 25 exerts control so that the sense of directionality that the driver Mn experiences due to the notification sounds is determined so as to correspond to the displayed positions of the virtual images Vi1, Vi2 and is linked to the virtual images Vi1, Vi2.

The vehicular information notification system 20 thus produces information associating both the virtual images Vi1, Vi2 and the notification sounds and thereby assists the driver Mn in perceiving and evaluating the direction of the virtual images Vi1, Vi2 projected on the windshield 11 and the distance in the longitudinal direction of the virtual images Vi1, Vi2 in relation to the windshield 11. In other words, the notification sounds that are linked to the virtual images Vi1, Vi2 are used to draw the attention of the driver Mn. The driver Mn can be made to perceive the position of the virtual images Vi1, Vi2 audibly as well as visually and can therefore be made to feel as if viewing a motion picture with sound. As a result, the driver Mn can become aware of information more quickly and appropriately.

The virtual image creation unit 23 in the present invention is not limited to a heads-up display (HUD); it may have any configuration capable of projecting a virtual image Vi onto the windshield 11. The virtual image creation unit 23 can also have, e.g., a configuration for projecting out from the top of the installment panel 12 only when necessary, i.e., a so-called pop-up configuration.

The nature of the notification sounds created by the notification sound creation unit 24 are not limited by frequency and sound pressure, and, e.g., combinations of frequency and sound pressure may also be used. The sound pressure may be changed instead of the frequency for the notification sounds outputted from the left and right speakers 32L, 32R in the embodiment shown in FIG. 5. The frequency may be changed instead of the sound pressure for the notification sounds outputted from the left and right speakers 32L, 32R in the embodiment shown in FIG. 8.

Phase differences may be provided to the respective left and right notification sounds on the basis of the position of the virtual image, and, e.g., the sense of directionality of the notification sounds corresponding to the position of the virtual image may be configured so as to trend more strongly across the widthwise direction of the vehicle than the actual spatial position when the direction of movement alone is to be emphasized.

### INDUSTRIAL APPLICABILITY

The vehicular information notification system 20 according to the present invention is particularly suitable for use on sedans, vans, and other passenger vehicles.

### LEGEND

10-vehicle; 11-windshield; 13-passenger compartment; 20-vehicular information notification system; 21-pole extension switch; 22-obstacle detection unit; 23-virtual image creation unit; 24-notification sound creation unit; 25-control unit; BL-lateral viewing-field line; ba-obstacle; CL-widthwise center line; FL-front-edge horizontal line; Fr-advancing direction of the vehicle; Mn-driver; Pf-first point; Pe-second point (vantage point); Vo-sound pressure; Vi1, Vi2-virtual image; Xo-relative distance between vehicle and barrier; Wo-distance in widthwise direction of vehicle

1. A vehicular information notification system for displaying information on a windshield of a vehicle and making a notification on the basis of the information, the vehicular information notification system comprising:
an obstacle detection unit for detecting an obstacle in front of the vehicle;
a virtual image creation unit capable of projecting a displaceable virtual image onto the windshield, the virtual image creation unit projects the virtual image onto the windshield at a position corresponding to a front edge of the vehicle and at a position corresponding to an edge in the widthwise direction of the vehicle;
a notification sound creation unit capable of creating a notification sound conforming to the virtual image, the notification sound creation unit creates the notification sound indicating that a lateral viewing-field line is a widthwise center of the vehicle, where the lateral viewing-field line is a straight line that passes through two points as viewed from above the vehicle, the first point being a position on the front edge of the vehicle and at a widthwise center of the vehicle, and the second point being a position corresponding to a position of a driver's eyes driving the vehicle; and,
a control part for controlling the virtual image creation unit and the notification sound creation unit, the control part controls the virtual image creation unit such that the virtual image is projected onto the windshield, the virtual image corresponding to the obstacle detected by the obstacle detection unit;
wherein the control part controls the virtual image creation unit such that the virtual image is displaced on the windshield in at least one of a direction corresponding to an advancing direction of the vehicle, a direction corresponding to a vertical direction relative to the advancing direction of the vehicle, and the widthwise direction of the vehicle, and controls the notification sound creation unit such that the notification sound is created to correspond to the displacement of the virtual image.

2. (canceled)

3. (canceled)

4. (canceled)

5. The vehicular information notification system of claim 1, wherein the control part controls the notification sound creation unit such that the notification sound is created intermittently based upon a relative distance between the vehicle and the obstacle.
